(19) United States
(12) Patent Application Publication
(10) Pub. No.: US 2025/0041879 A1
(43) Pub. Date: Feb. 6, 2025

(54) SMART HIGH-PRESSURE SYSTEM WITH SPRAYERS FOR SPRAYING AN END PRODUCT IN EMULSION WITH WATER TO SUPPRESS DUST EMITTED DURING THE MOVEMENT OF CEREALS

(71) Applicant: Marcos MAZZA, Buenos Aires (AR)

(72) Inventor: Marcos MAZZA, Buenos Aires (AR)

(21) Appl. No.: 18/720,112

(22) PCT Filed: Dec. 20, 2022
(86) PCT No.: PCT/CL2022/050132

§ 371 Date: Jun. 14, 2024

(30) Foreign Application Priority Data
Dec. 20, 2021 (AR) P20210103587

(51) Int. Cl. B05B 1/02; A01F 25/16; B02B 1/04; B05B 15/60

(52) U.S. Cl. CPC B05B 1/02; A01F 25/16; B02B 1/04; B05B 15/60

(57) ABSTRACT

A smart high-pressure system with sprayers for spraying an emulsified end product to suppress dust emitted during the movement of cereal grains, used in the field of agriculture, preferably in grain loading and collection terminals, and also in plants for producing vegetable oils, such as neutral soya bean oil and maize oil, glycerin and glycerin with 10% formic acid, wherein the system comprises a first fluid-managing module and a second fluid-managing module, operatively linked together by a circuit with a spraying arrangement comprising multiple electronically automated components connected to a programmable logic controller (PLC), arranged in a main control panel.

### FIELD OF THE INVENTION

The present invention refers to a smart high-pressure sprayer system for spraying a water emulsion final product to suppress the dust emitted during grain movements and in the agricultural industry, particularly in grain shipping and storage terminals, as well as in oil-producing plants, such as in the case of neutral soybean oil, corn oil, glycerin, 10% formic acid glycerin.

### BACKGROUND OF THE INVENTION

Cereal handling from the field to consumers results in more broken grains, and therefore more dust. Additionally, dust collection systems can sometimes increase the risk of fire. Techniques are also known that apply pure products and those of mineral origin directly on cereals.

Also known are publications of patent documents that deserve to be mentioned, and which refer to dust suction and collection techniques, namely:

Publication CN109078429 (A) refers to a water-circulating dust removal system for grain drying, which comprises a water-circulating tank, an air purification system, a water purification system, and a control device, and is characterized in that the air purification system comprises a dust removal chamber, a dust extractor and a sprayer, the dust extractor and the sprayer being arranged in the dust removal chamber from bottom to top, and the water-circulating tank supplying water for the sprayer; the water purification system comprises a solid-liquid separation zone, a sludge zone and a clean water zone, wherein the water separated by the solid-liquid separation zone passes through the bottom of the solid-liquid separation zone and flows to the clean water zone through a pipeline, and the water separated by the sludge zone passes through the top of the sludge zone and flows to the clean water zone through a pipeline.

Publication CN101502735 (A) refers to an efficient system for trapping micro-nanometer dust in the air. The invention comprises an air trapping opening, a filter core, a sprayer, a big and small flow micro pump, an atomizing nozzle, a liquid storage chamber, trapping liquid, a baffle, and a vacuum pump, which construct an airflow route and a liquid circulation route, to efficiently capture the micrometer and nanometer dust composed of various grains. By changing the variety of the trapping liquid or adjusting the hydrophile-lipophile balance (HLB) value of the trapping liquid, and improving the wettability of the trapping liquid and the nano dust in the air, micro nanometer fiber, thin sheet dust and other solid dust particles of various forms, containing micro-nano particles, can be efficiently trapped. The invention contains a plurality of air-liquid continuous contact processes, the air containing dust and the trapping liquid are only mixed and absorbed in the system, thus efficiently trapping nanodust in the air of various dust-density environments, including occupation workplace.

Publication CN205886468 (U) refers to dust collection equipment and discloses a high-pressure integrated form of fine dust-removing water mist system, which includes a box or cabin, wetting filter equipment, a water storage device, a supercharging and atomizer device, and further comprises a detachable construction structure, hydrating filter equipment, a water storage device, where the supercharging device and the atomizer are all integrated, the external water source is connected to the water inlet of the hydrating filter equipment, and a water storage device is used for water after storage is filtered, the water inlet of the supercharging device is linked to the outlet of the water tank, said outlet being connected to the atomizer, and this supercharging device is placed with the water extraction unit of the water storage device and the pressure boosts the high pressure spray pipe, the droplet being of uniform micron order which is distributed through high-pressure swirl injector with water explosion spraying, dust drop showing that high-pressure fine water smoke removes dust. The invention features a compact structure, with a small area and a high automation degree resulting in a good dust removal effect.

In this way, it is to be understood that the main problem lies in the emission of particulate matter (pollution) caused by the movement of cereals and by-products, together with economic loss suffered by companies due to volatile losses.

### SUMMARY OF THE INVENTION

It is then an object of the present invention to provide a device for capturing and retaining the particulate material released from cereal grains, employing electrostatic difference action by the use of a pure product of processed and organic vegetable origin in a water-emulsion, applied at high pressure on the batch of grains, which leads to a direct economic benefit for the companies and does not affect other parameters of the treated products (protein dilution, development of microorganisms such as salmonella, Escherichia coli, bacteria, mycotoxins, etc.), thereby obtaining a fundamental agri-food quality. An emulsion is a heterogeneous mixture of two immiscible liquids. One liquid (the dispersed phase) is dispersed in another (the continuous phase or dispersing phase).

It is also an object of the present invention to provide a smart system that works at a pressure between 40 bar (40.7886 Kg/cm2) to 200 bar (203.943 kg/cm2) depending on the area in which the end product is applied and with components such as two liquid tanks (water and vegetable oil), liquid pumps, spray nozzles, material detection barriers on belts, spray barriers behind grain unloading trucks, and electronic automation components, among others, with programming software previously filed for registration (DNDA Reg. No. RE2021-42985876-APN-DNDA).

It is, therefore, an object of the present invention to provide a smart high-pressure system with sprayers for spraying an emulsified final product to suppress the dust emitted during the movement of cereals, at a pressure between 40 bar (40.7886 20 Kg/cm2) to 200 bar (203.943 kg/cm2), applied in the agricultural field, preferably in shipping and grain storage terminals, as well as in plants producing vegetable oils such as neutral soybean oil, corn oil, glycerin, glycerin with 10% formic acid, and which comprises a first and second fluid management modules, operationally linked to each other, through a circuit having a spraying arrangement with multiple electronic automation components related to a programmable logic controller (PLC), arranged on a general board (11), where the first module (M1) has a tank (1) containing organic vegetable oil (Av) and the second module (M2) has a tank (2) containing water (Ag). In turn, both modules (M1, M2) are associated with a circuit that contains a secondary motor pump (3,4,5 and 6) with a check valve (17), as a means of suctioning fluids through a pipe branch (14) connecting to said container tanks (1,2). The inventive system also includes a connector coupling (15) with an elbow (16) linked to a spiral hose (18) attached to a coupling (19) of an elbow (20) with a nipple (21) connected to a T connector (22) in turn continuous with a nipple (23) coupled to a T connector (24) and another nipple (25) associated with a set of components defined by a flapper valve (26), a nipple (27), a flowmeter (28), a nipple (29), a coupler (30) with a connector coupling (31), in addition to a watertight box (32) and a dispenser (34) with a pipe branch (33) managing fluids and in turn linked to another secondary fluid outlet branch linked in turn to another secondary fluid outlet branch (rsav, rsag) linked to a main pipe branch for circulation of the end powder product (Ag+Av) suctioned by a main suction pump (7) and driven to a mechanism that contains automatic barriers (8,9) with spray nozzles (12,13) for spraying said final product on the cereal grains (Gc) to be treated.

### DESCRIPTION OF THE DRAWINGS

For the sake of clarity and a better understanding, the object of the present invention has been illustrated by several figures representing one of the preferred embodiments, all by way of example, in which:

FIG. 1 is a schematic plane view of the components of the smart sprayer system to be protected.

FIG. 2 illustrates the components involved in the operational modules included in said smart system.

FIG. 3 shows an exemplary embodiment of the spraying system on a tipper platform.

### DETAILED DESCRIPTION OF THE EXEMPLARY EMBODIMENT

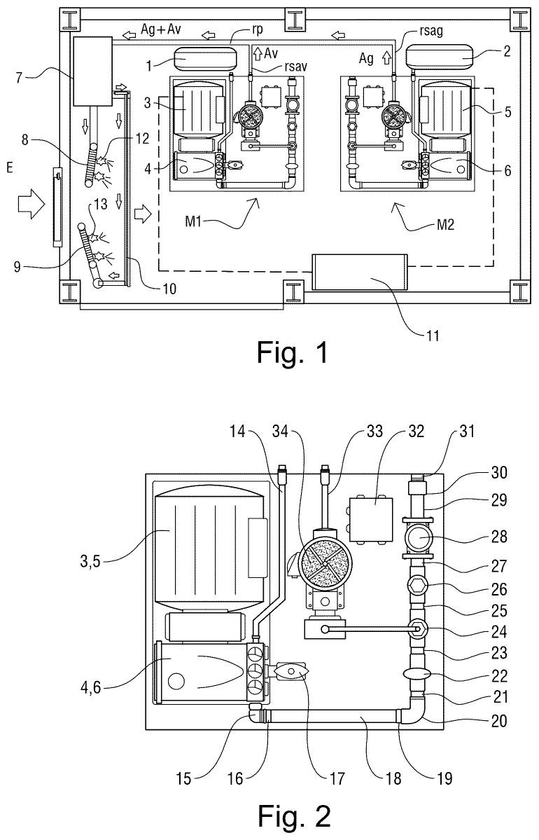

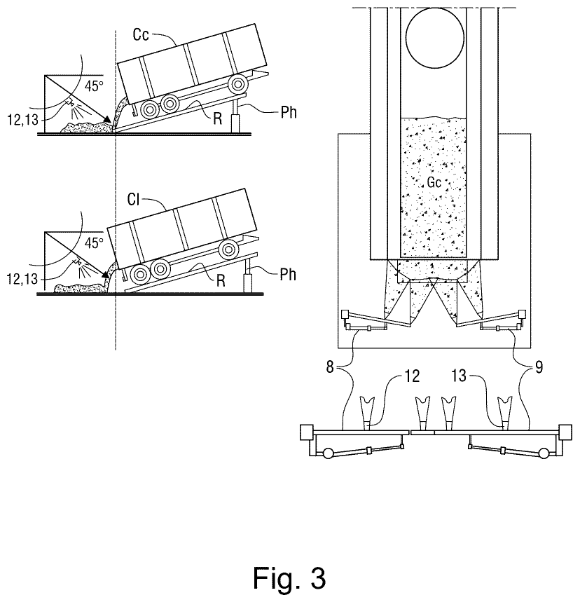

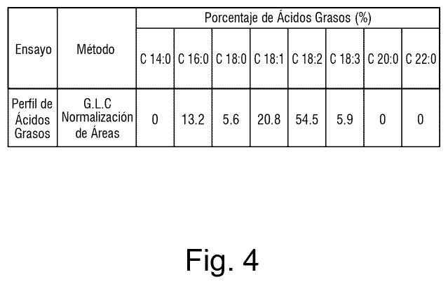

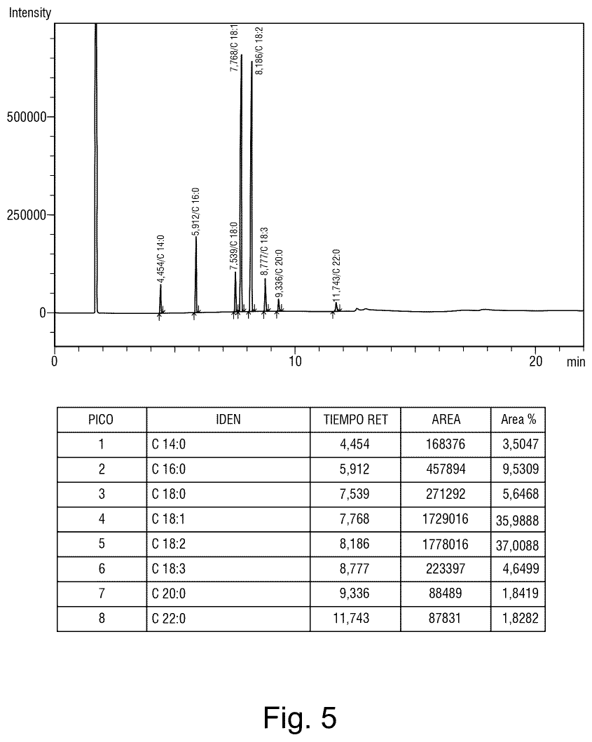

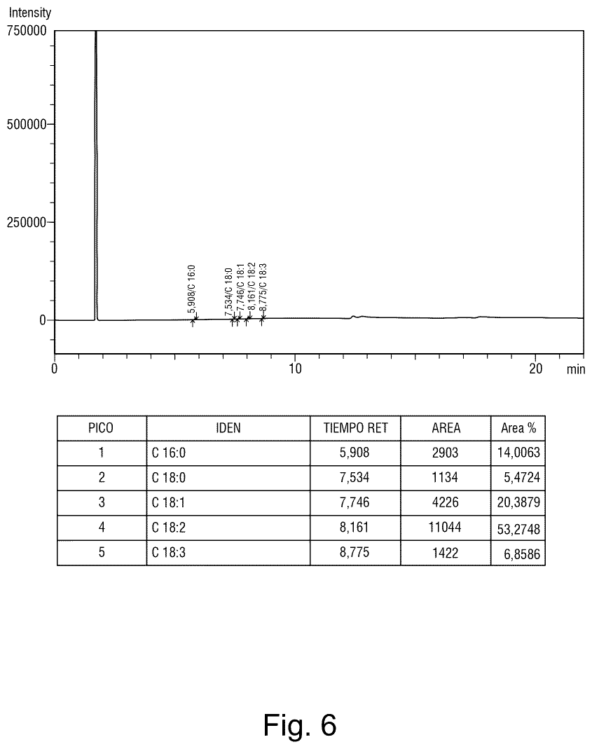

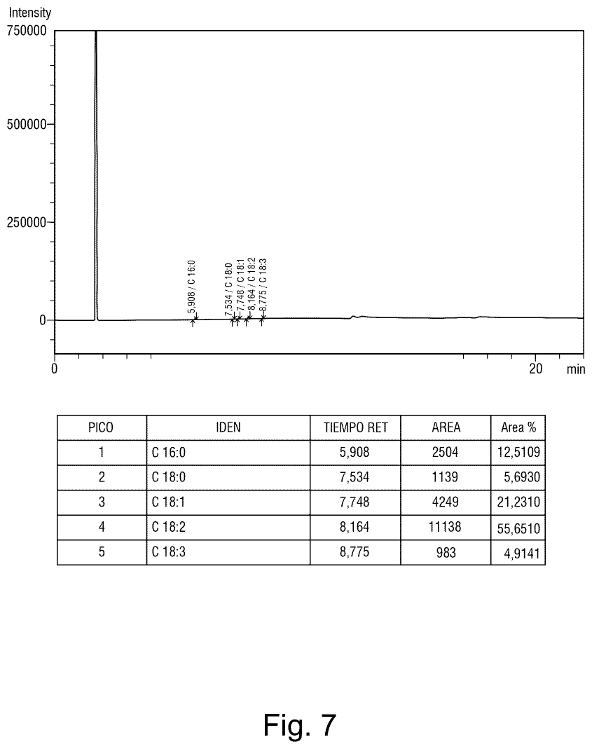

The components shown in FIG. 1 are the following:
M1: first organic vegetable oil management module.
M2: second water fluid management module.
Ag: fluid water.
Av: vegetable oil product.
Ag+Av: dust-suppressing emulsified end product
rsag: water supply and circulation secondary pipe branch (Ag).
rsav: vegetable oil supply and circulation secondary pipe branch (Av).
rp: main pipe branch for circulation of dust-suppressing end product (Av+Ag)
E: Transport entry direction of the cereal grains to be treated.
1. Organic vegetable oil tank (Av).
2. Water fluid tank (Ag).
3. M1 engine.
4. M1 secondary pump.
5. M2 engine.
6. M2 secondary pump.
7. Main suction pump for the dust-suppressing emulsified end product (Ag+Av).
8. First automatic opening and closing barrier.
9. Second automatic opening and closing barrier.
10. Dust-suppressing end product transmission duct.
11. General system control panel.
12. Suppressant emulsified end product spray nozzle (Ag+Av).
13. Suppressant emulsified end product spray nozzle (Ag+Av).
FIG. 2 shows the following components:
14. Pipeline branch (tubing 1″).
15. Connector coupling (2″ raccord).
16. 1″ elbow.
17. Check valve.
18. Spiral coiled hose (2″).
19. Connector coupling (2″ raccord).
20. Elbow (2″).
21. Nipple.
22. T connector, for 2″ dosing connection.
23. Nipple.
24. T connector, for 2″ dosing connection.
25. Nipple.
26. Flapper valve.
27. Nipple.
28. Flowmeter.
29. Nipple (2″).
30. Coupling
31. Connector coupling (2″ raccord).
32. Watertight box (150×150×100).
33. Fluid management pipe branch (¾″ tubing).
34. Dispenser (0.33 HP).
FIG. 3 shows the following components:
Gc: Cereal grains.
A: Ramp.
P: Hydraulic piston.
Cc: Short truck.
Cl: Long truck.
12,13. Spray nozzles for the dust-suppressing end product (Ag+Av).

Referring to FIGS. 1 and 2, the smart dust-suppressing system is unique on account of its purpose and functionality as able to emulsify the dust-suppressing product in water, which is achieved as follows:

Two tanks are arranged, one of water (Ag) raised at height (provided by the client's plant) and the other with another product (processed vegetable oil (Av)).

The water flows to a high-pressure piston motor pump (which can have different dimensions according to the flow rate of products to be treated).

The product (Av) is suctioned by another piston, diaphragm, or gear pump, and then injected into the water pipe with a check valve, in the appropriate proportion, to then obtain a dust-suppressing end product (Ag+Av) that flows towards the piston motor pump, where, in the same piston chamber, a superior and more homogeneous emulsion is made, and finally said end fluid product runs through a circuit of stainless steel pipes linked to high-pressure hoses of double and single metal mesh, directed to multiple stainless steel nozzles that spray said dust-suppressing end product on the merchandise that passes through a belt jump sector, well or tray conveyor header, on conveyor belts, a truck back loading and unloading sector, using the unique and exclusive automatic spray barrier system for dump trucks and any other convenient application point in the plant flow.

This entire circuit comprises a system with automation mechanisms connected to the plant signals that confirm the variation and presence of the material in the plant (amperage signal of the belt, tray conveyor, Redler transporting the merchandise) and reach a PLC where these signals are received and indicate the number of revolutions at which the motor pumps will operate, to regulate the frequency converters correspondingly.

Depending on the processed vegetable oil (Av), carbon chains similar to the treated goods create a magnetic field that attracts the dust, as shown by the relevant tests in FIGS. 4, 5, 6, and 7.

The spray nozzles will have a defined angle, height, depth, and direction according to the average mass of material discharged by short and long trucks. The sprayer nozzles located under the grate will be left installed, two located with one at each end, with the possibility of activating them in case a better dispersion of the total flow is required. The automation will respond to the signals coming from the elevation, maximum point, and descent of the platform.

The barriers will be open before the truck enters the platform.

Only when the truck is embedded in the platform, barriers will be closed to bring the spray nozzles near the grain discharge.

According to FIG. 3, the spray nozzles are placed at a height that exceeds the bulk of grains on the grates and are directed at an angle of 45° toward the cereal fall.

In the case of a short truck, the application occurs at the foot of the grain fall. In the case of long trucks, the application will take place in the middle of the fall.

In both cases, the spray will contact the grain within the distance along which the nozzle maintains its working pressure and, therefore, the grain will not volatilize to other points within the premises, such as the discharge pit.

Finally, it is to be noted that an optimal emulsion will be obtained if glycerin is used as it is a water-miscible product.

1. A smart high-pressure sprayer system of an emulsified end product to suppress dust emitted during cereal grain movements, between 40 bar (40.7886 Kg/cm2) to 200 bar (203.943 kg/cm2), applied in an agricultural field, preferably in shipping and grain storage terminals, as well as in plants producing vegetable oils such as neutral soybean oil, corn oil, glycerin, glycerin with 10% formic acid, said system comprising:
a first and second fluid management modules, operationally linked to each other, through a circuit with a sprayer arrangement having multiple electronic automation components related to a programmable logic controller (PLC), arranged on a general board, wherein the first module comprises a tank containing organic vegetable oil and the second module comprises a tank containing water; and, in turn, both modules are associated with a circuit that contains a secondary motor-pump with a check valve, as a means of suctioning fluids through a pipe branch connecting to said container tanks; and a connector coupling is also included which comprises an elbow linked to a spiral hose attached to a coupling with an elbow having a nipple connected to a T connector in turn continuous with a nipple coupled to a T connector and another nipple associated with a set of components defined by a flapper valve, a first nipple, a flowmeter, a second nipple, a coupler with a connector coupling, and additionally a watertight box and a dispenser with a fluid-managing pipe branch linked in turn to another secondary fluid outlet branch connected to a main pipe branch for circulation of an end powder product suctioned by a main suction pump and driven to a mechanism that contains automatic barriers with spray nozzles for spraying said end product on the cereal grains to be treated.
